(19) United States
(12) Patent Application Publication
(10) Pub. No.: US 2006/0238461 A1
(43) Pub. Date: Oct. 26, 2006

(54) Display device and driving method thereof

(75) Inventors: Joon-Chul Goh, Seoul (KR); Joon-Hoo Choi, Seoul (KR); Beohm-Rock Choi, Seoul (KR)

Correspondence Address: David W. Heid;MacPHERSON KWOK CHEN & HEID LLP, Suite 226, 1726 Technology Drive, San Jose, CA, 95110, US

(73) Assignee: Samsung Electronics Co., Ltd.

(21) Appl. No.: 11/408,278

(22) Filed: Apr. 19, 2006

(30) Foreign Application Priority Data
Apr. 21, 2005 (KR) 10-2005-0033149

(51) Int. Cl. G09G 3/30

(52) U.S. Cl. 345/76

(57) ABSTRACT

A display device includes a light emitting element connected to a common voltage, a driving transistor having a control terminal, an output terminal connected to the light emitting element, and an input terminal connected to a driving voltage, a first capacitor connected to the control terminal of the driving transistor, and a first switching transistor configured to transmit a data signal to the first capacitor. A first voltage is applied to the control terminal of the driving transistor, and a second voltage different from the first voltage and the driving voltage is applied to the output terminal of the driving transistor.

### CROSS-REFERENCE TO RELATED APPLICATION

This application claims priority from Korean Patent Application No. 2005-0033149 filed on Apr. 21, 2005, the disclosure of which is hereby incorporated herein by reference in its entirety for all purposes.

### BACKGROUND

1. Field of the Invention

The present invention relates generally to a display device, a driving method thereof, and in particular to an organic light emitting display (OLED) device and a driving method thereof.

2. Description of Related Art

Many consumers want electronic devices with displays to be light and thin. Examples of such electronic devices include mobile communication systems, digital cameras, notebook PCs, monitors, and televisions. One method of reducing display size and weight is to use flat panel displays, such as organic light emitting displays (OLED).

One type of flat panel display is an active matrix flat panel display. An active matrix flat panel display generally includes a plurality of pixels arranged in a matrix and displays images by controlling the luminance of the pixels based on luminance information indicative of a desired image.

An OLED is self-emissive. OLEDs have desirable characteristics such as a relatively wide viewing angle and a relatively high contrast ratio when compared to liquid crystal displays (LCDs). Further, because an OLED does not require a backlight assembly, OLEDs are lighter and consume less power than LCDs. Other advantageous features include a fast response time, a wide range of operating temperatures, and low manufacturing cost.

A pixel of an OLED includes a light emitting element and a driving transistor. The light emitting element emits light having an intensity value that is dependent on the current driven by the driving transistor, which in turn depends on the threshold voltage of the driving transistor and the voltage between gate and source of the driving transistor.

The driving transistor is typically classified as either a polysilicon thin film transistor (TFT) or an amorphous silicon TFT, depending upon the type of semiconductor active layer. A polysilicon transistor has several advantages, but it also has disadvantages such as the complexity of manufacturing polysilicon, thereby increasing the manufacturing cost. In addition, it is difficult to make a wide screen OLED employing polysilicon transistors.

To the contrary, a wide screen OLED manufactured with amorphous silicon transistors is easily obtained and is manufactured using less process steps than an OLED with polysilicon transistors. However, the threshold voltage (Vth) of the amorphous silicon transistor shifts over time, so that the current flowing in the light emitting element is non-uniform, resulting indegraded image quality.

Thus, there is a need for compensating the threshold voltage shift of the driving transistor and reducing the driving voltage, thereby reducing image degradation.

### SUMMARY OF THE INVENTION

Embodiments of the present invention provide a display device capable of compensating the threshold voltage shift of the driving transistor and a driving method thereof to reduce image degradation.

In an exemplary display panel according to some embodiments of the present invention, the display device includes a light emitting element connected to a common voltage, a driving transistor having a control terminal, an input terminal connected to a driving voltage, an output terminal connected to the light emitting element, a first capacitor connected to the control terminal of the driving transistor, and a first switching transistor configured to connect a data signal to the first capacitor in response to a first gate signal. A first voltage different from the driving voltage is applied to the control terminal of the driving transistor, and a second voltage different from the first voltage is applied to the output terminal of the driving transistor.

The display device further comprises a second switching transistor configured to connect the first voltage to the control terminal of the driving transistor in response to a second gate signal, a third switching transistor configured to connect the first capacitor to the output terminal of the driving transistor in response to the second gate signal, and a fourth switching transistor configured to connect the second voltage to the output terminal of the driving transistor in response to a third gate signal. The third gate signal can be the second signal for the previous row pixel.

The first voltage may be larger than the second voltage, with the difference between the first voltage and the second voltage larger than the threshold voltage of the driving transistor. The second voltage may be less than the sum of the common voltage and the threshold voltage of the light emitting element, where this sum may be larger than the difference of the first voltage and the threshold voltage of the driving transistor.

The first capacitor stores the difference between the first voltage and the second voltage and then stores the threshold voltage of the driving transistor. The display device further comprises a second capacitor connected to the first capacitor and the first voltage.

In another exemplary display panel according to some embodiments of the present invention, the display device includes a plurality of pixels, where each pixel includes a driving transistor having a control terminal connected to a first node, an output terminal connected to a second node, an input terminal connected to a driving voltage, a light emitting element connected to the second node, a first capacitor connected between the first node and a third node, a first switching transistor connected between the third node and a data signal, a second switching transistor connected between the first node and a first voltage, a third switching transistor connected between the second node and the third node, and a fourth switching transistor connected between the second node and a second voltage.

The display device further comprises a second capacitor between the third node and the first voltage.

The first switching transistor operates responsive to a first gate signal, and the second and the third switching transistors operate responsive to a second gate signal. The fourth switching transistor operates responsive to a third gate signal, which can be the second gate signal for the previous row pixel.

The display device further comprises a first gate line, a second gate line; and a third gate line configured to transmit the first gate signal, the second gate signal, and the third gate signal respectively. The third gate line can be the second gate line connected to the previous row pixel.

In an exemplary method of driving a display device with a driving transistor having a control terminal connected to a first node, an output terminal connected to a second node, an input terminal connected to a driving voltage, a light emitting element connected to the second node, and a capacitor connected between the first node and a third node, the method includes connecting a first voltage to the second node to prevent light emission of the light emitting element, connecting a second voltage larger than the first voltage to the first node, disconnecting the first voltage from the second node, disconnecting the second voltage form the first node, and connecting a data signal to the third node.

The connecting the second voltage to the first node may include connecting the second node and the third node. The disconnecting the second voltage from the first node may include disconnecting the second node and the third node.

Disconnecting the data signal from the third node can follow the connecting the data signal to the third node.

### BRIEF DESCRIPTION OF THE DRAWINGS

The features of the present invention will become more apparent to those of ordinary skill in the art in light of the below described exemplary embodiments thereof with reference to the attached drawings, in which:

FIG. 1 is a block diagram of an OLED according to an embodiment of the present invention;

FIG. 2 is an equivalent circuit diagram of a pixel of the OLED of FIG. 1

FIG. 3 is a cross-sectional view of a driving transistor and a light emitting element of a pixel of the OLED of FIG. 2 according to an embodiment of the present invention;

FIG. 4 is a schematic view illustrating a multi layered structure of a light emitting member of FIG. 3;

FIG. 5 is a timing diagram illustrating several signals for operating an OLED such as the OLED of FIG. 1 according to an embodiment of the present invention;

FIGS. 6A to 6D are equivalent circuits corresponding to each period of the timing diagram of FIG. 5;

FIG. 7 is a block diagram of an OLED according to another embodiment of the present invention;

FIG. 8 is an equivalent circuit diagram of a pixel of the OLED of FIG. 7; and

FIG. 9 is a timing diagram illustrating several signals for operating the OLED of FIG. 7 according to another embodiment of the present invention.

Use of the same reference symbols in different figures indicates similar or identical items.

### DETAILED DESCRIPTION OF PREFERRED EMBODIMENTS

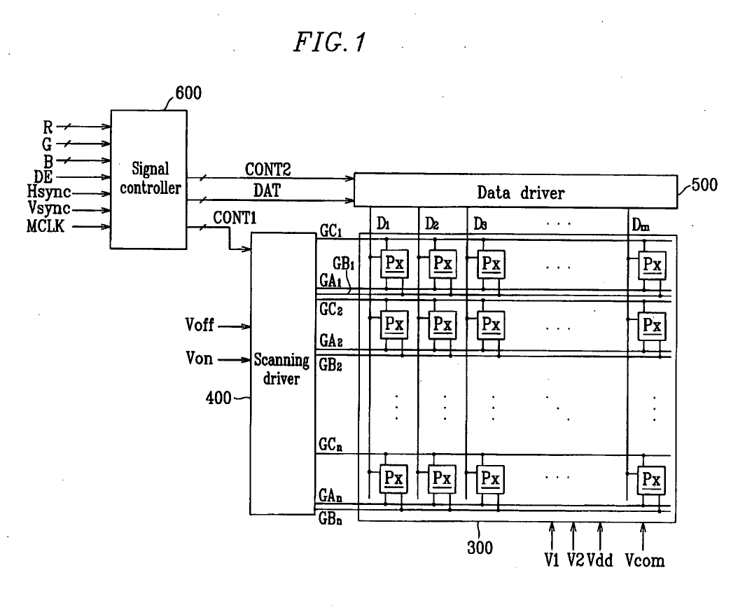

FIG. 1 is a block diagram of an OLED according to an embodiment of the present invention. The OLED includes a display panel 300, a scanning (i.e., gate) driver 400 and a data driver 500 connected to display panel 300, and a signal controller 600 connected to scanning driver 400 and data driver 500.

Display panel 300 includes first gate lines GA₁-GAₙ, second gate lines GB₁-GBₙ, third gate lines GC₁-GCₙ, data lines D₁-Dₘ, power supply lines (not shown), and a plurality of pixels Px. Gate lines carry gate signals and extend substantially parallel to one another, in a horizontal direction (in the example shown in FIG. 1), along rows of pixels. Data lines D₁-Dₘ carry data signals and extend substantially parallel to one another in a vertical direction along columns of pixels. Power supply lines (not shown) carry a first voltage V₁, a second voltage V₂, and a driving voltage Vdd. In the embodiment illustrated in FIG. 1, pixels are arranged in a matrix configuration and are connected to gate lines, data lines D₁-Dₘ, and power supply lines.

Scanning driver 400 provides gate signals VA₁-VAₙ, VB₁-VBₙ, and VC₁-VCₙ to gate lines GA₁-GAₙ, GB₁-GBₙ, GC₁-GCₙ, respectively, where the gate signals are either Voff (a voltage sufficient to turn off the associated transistor) or Von (a voltage sufficient to turn on the associated transistor). Data driver 500 provides data voltages V_{dat} (or data signals) to data lines D₁-Dₘ corresponding to image signals.

In some embodiments, scanning driver 400 and/or data driver 500 are included in chips mounted directly on display panel 300, or on flexible printed circuit films. In some embodiments, scanning driver 400 and/or data driver 500 can be integrated on display panel 300.

Signal controller 600 controls scanning driver 400 and data driver 500. (Image signals (e.g., R, G, and B signals) and input control signals, such as a data enable signal DE, a vertical synchronization signal V_{sync} to activate a frame, a horizontal synchronization signal H_{sync} to activate a line, and a main clock MCLK from an external graphic controller (not shown), are provided to signal controller 600. Signal controller 600 generates scanning control signals CONT1 and data control signals CONT2 by processing input control signals. Signal controller 600 also converts image signals R, G, and B to image data DAT suitable for display panel 300.

Scanning control signals CONT1 are provided to scanning driver 400 and include a scanning start signal to initiate scanning of the voltage Von and at least one clock signal for controlling the output time of the gate-on voltage Von. The scanning control signals CONT1 may include a plurality of output enable signals for defining the duration of the gate-on voltage Von.

The data control signals CONT2 are provided to data driver 500 and include a horizontal synchronization start signal for initiating data transmission for a group of pixels Px in a row, a load signal instructing data driver 500 to apply the data voltages to the data lines D₁-Dₘ, and a data clock signal.

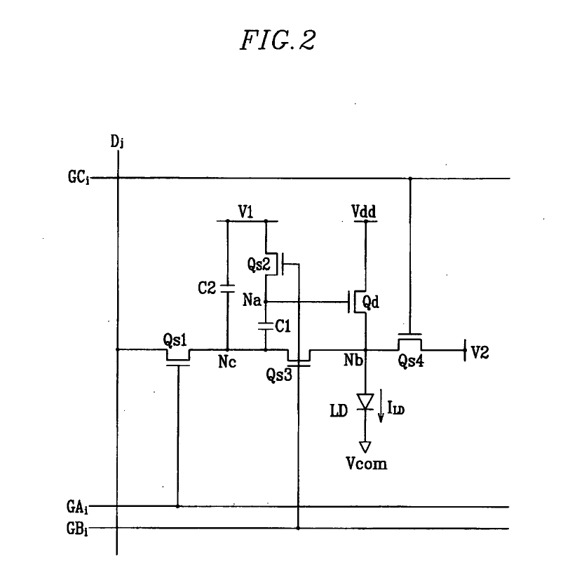

FIG. 2 is a pixel Px of an OLED such as that illustrated in FIG. 1, according to an embodiment of the present invention. Pixel Px includes four switching transistors Qs1-Qs4, a driving transistor Qd, two capacitors C1 and C2, and a light emitting element LD, such as an LED.

Driving transistor Qd has a control terminal, an input terminal, and an output terminal. The control terminal is connected to a node Na connected between second switching transistor Qs2 and first capacitor C1. The input terminal is provided with driving voltage Vdd, and the output terminal is connected to a node Nb connected to third switching transistor Qs3, fourth switching transistor Qs4, and light emitting element LD.

First capacitor C1 is connected between node Na and a node Nc connected to first switching transistor Qs1, third switching transistor Qs3, and second capacitor C2. Second capacitor C2, which is optional, is connected between a first voltage V1 and node Nc.

Light emitting element LD is connected between node Nb and a common voltage Vcom. Light emitting element LD emits light having intensity depending on the output current I_{LD} supplied by driving transistor Qd. Driving current I_{LD} depends on the voltage difference Vgs between the control terminal and the output terminal of driving transistor Qd.

First switching transistor Qs1 is connected to an associated first gate line GAᵢ, a data line Dⱼ, and node Nc, where first switching transistor Qs1 operates in response to a first gate signal VAᵢ supplied by first gate line GAᵢ. Second switching transistor Qs2 is connected to an associated second gate line GBᵢ, first voltage V₁, and node Na, where switching transistor Qs2 operates in response to a second gate signal VBᵢ supplied by second gate line GBᵢ. Third switching transistor Qs3 is connected to an associated gate line GBᵢ, node Nb, and node Nc, where switching transistor Qs3 operates in response to second gate signal VBᵢ. Fourth switching transistor Qs4 is connected to an associated third gate line GCᵢ, second voltage V₂, and node Nb, where switching transistor Qs4 operates in response to third gate signal VCᵢ supplied by gate line GCᵢ.

In some embodiments, switching transistors Qs1 to Qs4 and the driving transistors Qd are n-type transistors (e.g., FETs) of amorphous silicon or polysilicon. In other embodiments, the transistors Qs and Qd may be p-type transistors operating in a manner opposite to n type transistor.

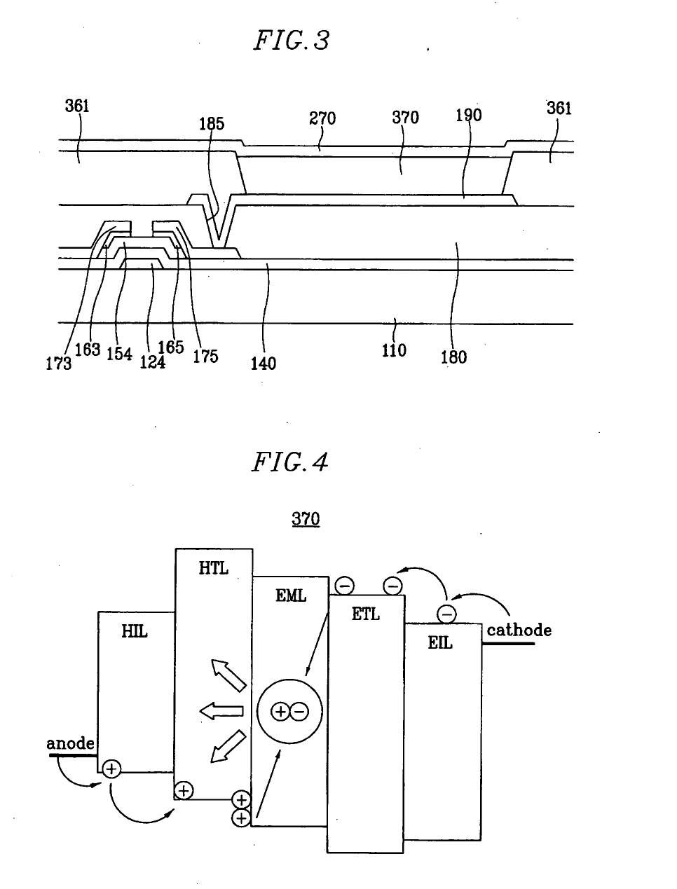

FIG. 3 is a cross sectional view of driving transistor Qd and light emitting element LD of a pixel of an OLED according to an embodiment of the present invention.

A control electrode 124 of driving transistor Qd is formed on an insulating substrate 110. In some embodiments, control electrode 124 is made of an Al containing metal such as Al and Al alloy, an Ag containing metal such as Ag and Ag alloy, a Cu containing metal such as Cu and Cu alloy, an Mo containing metal such as Mo and Mo alloy, Cr, Ti, or Ta. Control electrode 124 may have a multi-layered structure including two conductive films having different physical characteristics. One of the two films is made of a low resistivity metal, such as an Al containing metal, an Ag containing metal, or a Cu containing metal, for reducing signal delay or voltage drop. The other film is made of a material such as a Mo containing metal, Cr, Ta or Ti, which has good physical, chemical, and electrical contact characteristics with materials such as indium tin oxide (ITO) or indium zinc oxide (IZO). Examples of the combination of the two films are a lower Cr-based film with an upper Al (alloy) based film and a lower Al (alloy) based film with an upper Mo (alloy) based film. The control electrode 124 may be made of various metals or conductors. The lateral side of control electrode 124 is inclined at an angle between about 30 and about 80 degrees relative to the surface of insulating substrate 110.

An insulating layer 140 such as a silicon nitride SiNx layer is formed on control electrode 124 and insulating substrate 110. A semiconductor 154 such as hydrogenated amorphous silicon or polycrystalline silicon is formed on insulating layer 140. A pair of ohmic contact layers 163 and 165 that may comprise silicide or n+ hydrogenated amorphous silicon doped with an n-type impurity is formed on semiconductor 154. The lateral sides of semiconductor 154 and ohmic contact layers 163 and 165 are inclined at an angle of about 30 to about 80 degrees relative to the surface of insulating substrate 110.

An input electrode 173 and an output electrode 175 are formed on ohmic contact layers 163 and 165 and insulating layer 140. Input electrode 173 and output electrode 175 are separated from one another and are each over a side of control electrode 124. In some embodiments, input electrode 173 and output electrode 175 are made of refractory metal such as Cr, a Mo-based metal, Ti, Ta or alloys thereof. The electrodes may have a multilayered structure including a refractory metal-based lower film (not shown) and a low resistivity upper film (not shown). Examples of the multi-layered structure are a double-layered structure including a lower Cr or Mo (alloy) based lower film with an upper Al (alloy) based film and a triple-layered structure of a lower Mo (alloy) based film, an intermediate Al (alloy) based film, and an upper Mo (alloy) based film. The lateral sides of input electrode 173 and output electrode 175 are inclined at an angle between about 30 and about 80 degrees.

Control electrode 124, input electrode 173, and output electrode 175 with semiconductor 154 form driving transistor Qd. The channel of driving transistor Qd is formed on semiconductor 154 between input electrode 173 and output electrode 175. Ohmic contacts 163 and 165 are interposed only between the underlying semiconductor 154 and the overlying electrodes 173 and 175 thereon to reduce the contact resistance therebetween.

A passivation layer 180 is formed on input electrode 173, output electrode 175, the exposed portion of semiconductor 154, and insulating layer 140. In one embodiment, passivation layer 180 comprises an inorganic insulating material such as silicon nitride or silicon oxide, an organic insulating material, or a low dielectric constant insulating material that has a dielectric constant of 4.0 or less such as a-Si:C:O or a-Si:O:F formed by plasma enhanced chemical vapor deposition (PECVD). In some embodiments, passivation layer 180 can be made of a photosensitive organic insulating material with a flattened surface. Alternatively, passivation layer 180 may have a double layered structure including a lower inorganic layer and an upper organic layer to enable protection of the exposed portion of semiconductor 154 while providing advantages of the organic layer.

Passivation layer 180 has a contact hole 185 to expose a portion of output electrode 175.

A pixel electrode 190 is formed on passivation layer 180 to connect electrically and physically to output electrode 175 through contact hole 185. Pixel electrode 190 is formed of transparent conductive material such as indium tin oxide (ITO) and/or indium zinc oxide (IZO), or a double layered structure including a transparent conductive material and a reflective material such as Cr, Al, and/or Ag.

A partition 361 made of organic or inorganic insulating material is formed on passivation layer 180 and has an opening to expose a portion of pixel electrode 190. An organic light emitting member 370 is formed on the portion of pixel electrode 190 bounded by partition 361.

A common electrode 270 to be supplied with a common voltage Vcom is formed on organic light emitting member 370 and partition 361. When the pixel electrode 190 is transparent, common electrode 270 may comprise a reflective metal, such as Ca, Ba, or Al, or a transparent conductive material, such as ITO or IZO.

A combination of an opaque pixel electrode 190 and a transparent common electrode 270 is employed in a top emission type OLED that emits light toward the top of display panel 300. A combination of a transparent pixel electrode 190 and an opaque common electrode 270 is employed in a bottom emission type OLED that emits light toward the bottom of the display panel 300.

Pixel electrode 190, organic light emitting member 370, and common electrode 270 form a light emitting element LD having pixel electrode 190 as an anode and common electrode 270 as a cathode or vice versa. Light emitting element LD uniquely emits one of a set of primary color lights, depending on the material of light emitting member 370. An exemplary set of primary colors includes three primary colors: red, green, and blue. The desired image is obtained by the combination of the three primary colors.

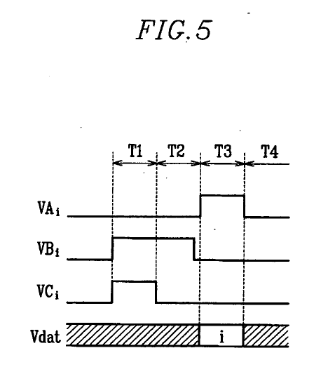

Referring to FIG. 4, organic light emitting member 370 has a multilayered structure including an emitting layer EML and optional auxiliary layers for improving the efficiency of light emission of the emitting layer EML. The auxiliary layers include an electron transport layer ETL and a hole transport layer HTL for improving the balance of the electrons and holes and an electron injecting layer EIL and a hole injecting layer HIL for improving the injection of the electrons and holes.

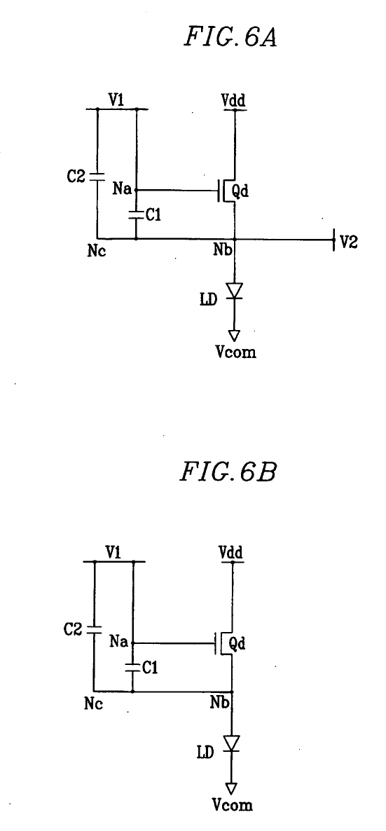

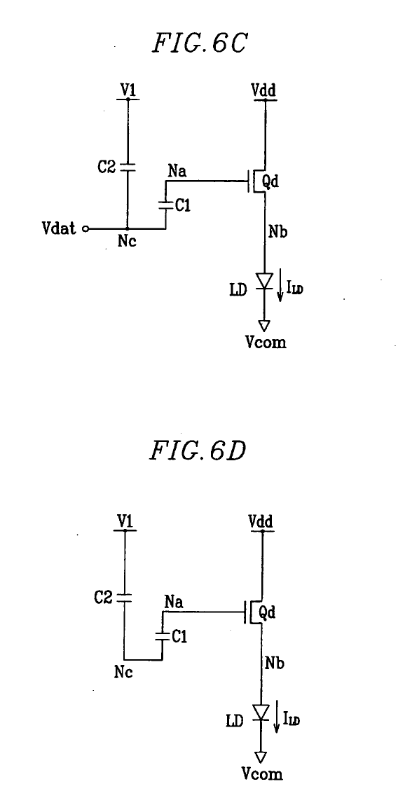

FIG. 5 is a timing diagram illustrating several signals for operating an OLED such as that illustrated in FIG. 1 according an embodiment of the present invention. FIGS. 6A to 6D are equivalent circuits of a pixel illustrated in FIG. 2 corresponding to one of sub periods T₁, T₂, T₃, and T₄ of FIG. 5 according to an embodiment of the present invention.

First voltage V1 and second voltage V2 of FIG. 2 are determined to satisfy following equations 1-3. In one embodiment, first voltage V1 is the same ground level as common voltage Vcom, and second voltage V2 may have a negative value to satisfy following equations. Driving voltage Vdd is larger than common voltage Vcom and may be equal to first voltage V1.
V₁−V₂>Vthd (1)
Vcom+Vtho>V₂ (2)
Vcom+Vtho>V₁−Vtho (3)

where Vthd is the threshold voltage of driving transistor Qd, and Vtho is the threshold voltage of light emitting element LD.

An operation period of a pixel during a frame is divided to four sub periods having an initial period T₁, a programming period T₂, a data input period T₃, and an emission period T₄. The following description is generalized for the ith pixel row.

Initial Period (T₁)

In response to scanning control signals CONT1 from signal controller 600, scanning driver 400 generates gate signal VBᵢ for gate line GBᵢ and gate signal VCᵢ for gate line GCᵢ equal to the gate-on voltage Vₒₙ, thereby turning on second and third switching transistors Qs2 and Qs3 connected to gate line GBᵢ and fourth switching transistor Qs4 connected to gate line GCᵢ, respectively. At this time, gate signal VAᵢ for gate line CAᵢ is at the gate-off voltage Voff to turn off first switching transistor Qs1 connected to gate line GAᵢ.

FIG. 6A illustrates an equivalent circuit of a pixel of FIG. 2 during initial period T₁. First voltage V₁ is applied to node Na, and second voltage V₂ is applied to node Nb. As shown in equation 1, a voltage difference between first voltage V₁ and second voltage V₂ is larger than a threshold voltage Vthd of driving transistor Qd to turn on driving transistor Qd and enables current dependent on the voltage difference (V₁−V₂) to flow through. However, light emitting element LD turns off because second voltage V₂ is less than the sum of common voltage Vcom and threshold voltage Vtho of light emitting element LD, as shown in equation 2. Since light emitting element LD is off, the output current flows to a power supply line configured to transmit second voltage V₂ through fourth switching transistor Qs4 without flowing through light emitting element LD. The voltage difference (V₁−V₂) between the first voltage and the second voltage charges first capacitor C₁ to maintain voltage difference (V₁−V₂) for a desired period.

Programming Period (T₂)

Scanning driver 400 then changes gate signal VCᵢ for gate line GCᵢ to the gate-off voltage Voff, thereby turning off fourth switching transistor Qs4. Gate signal VAᵢ is maintained at the gate-off voltage Voff to keep first switching transistor Qs1 off. Second gate signal VBᵢ is kept at the gate-on voltage Von to keep second switching transistor Qs2 and third switching transistor Qs3 on. The voltage difference stored in first capacitor C₁ during initial period T₁ keeps driving transistor Qd turned to enable current flow.

FIG. 6B illustrates an equivalent circuit of a pixel of FIG. 2 during programming period T₂. Second voltage V₂ is separated from node Nb, and a path of current flow from driving transistor Qd disappears. Accordingly, the current charges node Nb to increase a voltage of node Nb. As voltage of node Nb increases and voltage V1 is continuously applied to node Na, the voltage difference Vgs between the control terminal and the output terminal of driving transistor Qd decreases. This causes the output current of driving transistor Qd to reduce. The voltage of node Nb increases until voltage difference Vgs between the control terminal and the output terminal of driving transistor Qd equals the threshold voltage Vthd of driving transistor Qd, resulting in no current flow out from driving transistor Qd. That is, the voltage of node Nb becomes equal to a voltage difference (V₁−Vthd) between first voltage V, and threshold voltage Vthd of driving transistor Qd. As the voltage difference (V1−V2) becomes greater, the approximation of node Nb to the value (V₁−Vthd) becomes more stable.

The voltage difference (V₁−Vthd) is less than the sum of common voltage Vcom and threshold voltage Vtho of light emitting element LD as shown in equation 3. This maintains light emitting element LD in an off state during programming period T₂ and makes no path for the output current from driving transistor Qd. Accordingly, first capacitor C₁ stores the threshold voltage Vthd of driving transistor Qd, which is equal to the voltage difference Vgs between the control terminal and the output terminal of driving transistor Qd.

At the start of programming period T₂, first capacitor C₁ stores the voltage difference (V₁−V₂) charged during initial period T1. However, at the end of programming period T2, first capacitor C₁ stores the threshold voltage Vthd of driving transistor Qd.

After the threshold voltage Vthd of driving transistor Qd charges first capacitor C₁, scanning driver 400 changes gate signal VBᵢ to the gate-off voltage Voff to turn off second and third switching transistor Qs2 and Qs3. First capacitor C₁ is then kept in a floating state with stored threshold voltage Vthd.

Data Input Period (T3)

After a predetermined period of time and in response to data control signals CONT2 from signal controller 600, data driver 500 receives a group of image data DAT, for example, data for the ith pixel row, from signal controller 600. Data driver 500 converts the image data DAT into analog data voltages Vdat, which are applied to data lines D₁-Dₘ.

Upon or after receiving data voltage Vdat, scanning driver 400 increases gate signal VAᵢ for gate line GAᵢ to the gate-on voltage Von, thereby turning on first switching transistor Qs1 connected to first gate line GAᵢ for data input. Second gate signal VBᵢ and third gate signal VCᵢ are maintained at the gate-off voltage Voff.

FIG. 6C illustrates an equal circuit of a pixel of FIG. 2 during data input period T₃. The data voltage Vdat is applied to node Nc through first switching transistor Qs1. Due to the bootstrapping effect, the first capacitor C₁ provides the data voltage Vdat to the control terminal of driving transistor Qd (i.e., node Na), resulting in a voltage at node Na equal to the sum of the data voltage Vdat and the threshold voltage Vthd (i.e., Vdat+Vthd). The driving transistor Qd turns on to output the driving current I_{LD} to the light emitting element LD depending on the amount of the data voltage Vdat.

Accordingly, even if the OLED is driven for a long period of time and the threshold voltage Vthd of driving transistor shifts, the shifted threshold voltage Vthd is applied to node Na so that driving transistor Qd can provide light emitting element LD with a constant driving current I_{LD} dependent on the amount of the data voltage Vdat.

Emission Period (T4)

After the data input period ends, scanning driver 400 generates gate signal VAᵢ for gate line GAᵢ equal to the gate-off voltage Voff, thereby turning off first switching transistor Qs1. Gate signals VBᵢ and VCᵢ are maintained at the gate-off voltage Voff.

Driving transistor Qd outputs the driving current I_{LD} to light emitting element LD, which depends on the voltage difference Vgs between the control terminal and the output terminal of driving transistor Qd. Driving current I_{LD} flows through light emitting element LD, which emits light having different intensities depending on driving current I_{LD}, to produce the desired images.

During emission period T₄, driving current I_{LD} is determined by the following equation.

$$\begin{matrix}{I}_{LD} = 1 / 2 \times K \times {( Vgs - Vthd )}^{2} \\ = 1 / 2 \times K \times {( Vdat + Vthd - Vns - Vthd )}^{2} \\ = 1 / 2 \times K \times {( Vdat - Vns )}^{2}\end{matrix} \qquad ( 4 )$$

where K is a constant dependent on a characteristic of driving transistor Qd and is equal to μ×Ci×W/L, where μis charge or field effect mobility, Ci is the capacitance of the gate insulating layer of driving transistor Qd, W is the channel width of driving transistor Qd, and L is the channel length of driving transistor Qd), and Vns is a voltage of output terminal of driving transistor Qd.

As seen from equation 4, driving current I_{LD} is not dependent on the threshold voltage Vthd of driving transistor Qd. Second capacitor C₂, which is optional, maintains a stable voltage at the control terminal of driving transistor Qd stable during emission period T4.

Emission period T₄ lasts until the initial period T₁ for a next frame starts for the next row of pixels. Data input period T₃ for the (i+1) th pixel row can start after data input period T₃ for the i-th pixel row ends. By repeating this procedure for each pixel Px in subsequent rows, all gate lines GA₁-GAₙ, GB₁-GBₙ, and GC₁-GCₙ are sequentially provided with the gate-on voltage Vₒₙ, thereby applying the data voltages to all pixels and displaying the associated images. Each period T₁ to T₄ can be adjusted.

According to this embodiment, the shifted threshold voltage is compensated (i.e., the shifted threshold voltage is applied to the control terminal of the driving transistor) and driving current is independent of the threshold voltage shift of the driving transistor, thereby preventing and reducing the image degradation.

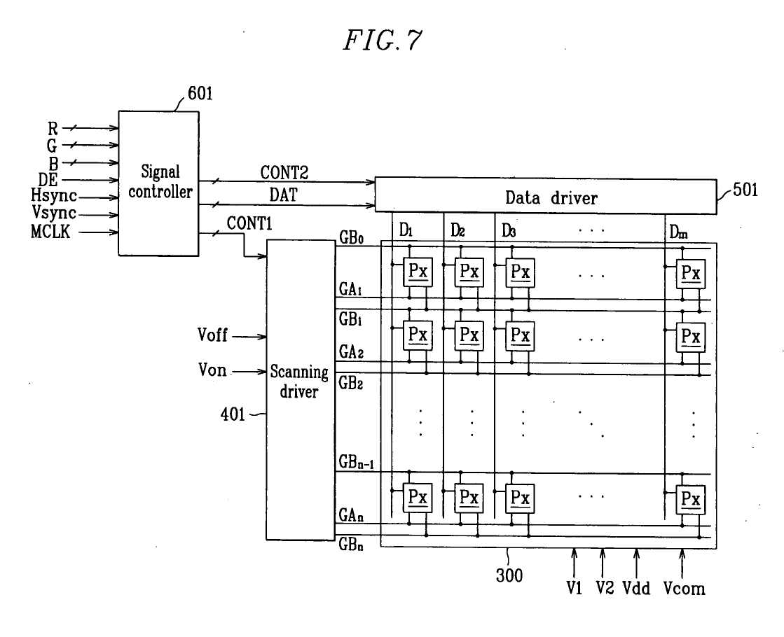

FIGS. 7 to 9 illustrate another embodiment of this present invention. The OLED of this embodiment is similar to the organic light emitting display of FIGS. 1 and 2, except for the absence of third gate lines. Accordingly, duplicate explanations are omitted.

FIG. 7 is a block diagram of an OLED, which includes a display panel 301, a scanning (i.e., gate) driver 401 and a data driver 501 connected to display panel 301, and a signal controller 601.

Display panel 301 includes gate lines having first gate lines GA₁-GAₙ and second gate lines GB₀-GBₙ, data lines D₁-Dₘ, a plurality of power supply lines (not shown), and a plurality of pixels Px arranged in a matrix.

Gate lines GB₀-GBₙ carry gate or scanning signals and extend substantially parallel to one another, in a horizontal or row direction (in the example shown in FIG. 7). Data lines D₁-Dₘ carry data signals and extend substantially parallel to one another and perpendicular to the gate lines in a column direction. Power supply lines (not shown) carry a first voltage V₁, a second voltage V₂, and a driving voltage Vdd.

Scanning driver 401 provides gate signals VA₁-VAₙ and VB₀-VBₙ to associated gate lines, where the gate signals are either Voff (a voltage sufficient to turn off the associated transistor) or Von (a voltage sufficient to turn on the associated transistor).

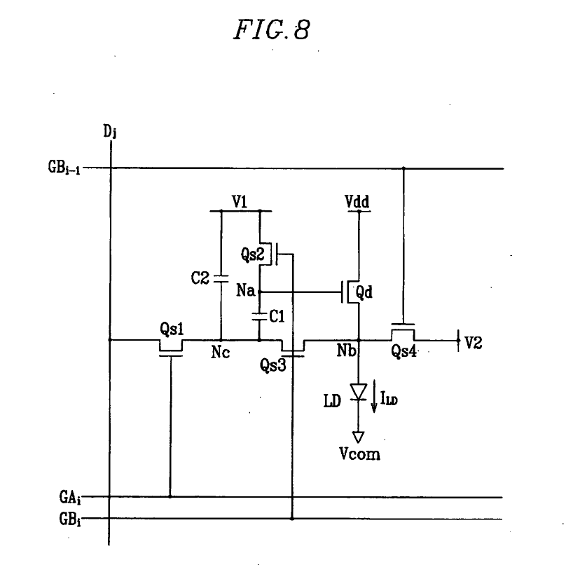

FIG. 8 is a pixel Px of an OLED such as that illustrated in FIG.7, according to another embodiment of the present invention. The pixel Px at the i-th row and j-th column is connected to the ith gate lines GAᵢ and GBᵢ, the (i−1)th second gate line GB₍ᵢ₋₁₎ (i.e., previous second gate line), and the jth data line Dⱼ. Pixel Px includes four switching transistors Qs1 to Qs4, a driving transistor Qd, two capacitors C1 and C2, and an organic light emitting element LD.

Switching transistor Qs4 is connected to the previous second gate line GB₍ᵢ₋₁₎ instead of gate line GCᵢ of FIG. 2, second voltage V₂, and a node Nb. Switching transistor Qs4 operates in response to signal VB₍ᵢ₋₁₎ for the previous second gate line GB₍ᵢ₋₁₎.

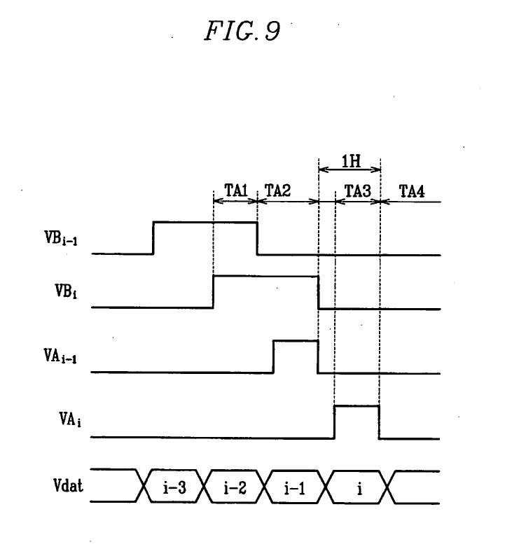

FIG. 9 is a timing diagram illustrating several signals for operating an OLED illustrated in FIGS. 7 and 8 according to an another embodiment of the present invention.

During an initial period TA₁, second gate signal VBᵢ increases to the gate-on voltage Von when the previous second gate signal VB₍ᵢ₋₁₎ is at the gate-on voltage Von. During a programming period TA₂, the previous second gate signal VB₍ᵢ₋₁₎ decreases to the gate-off voltage Voff when second gate signal VBᵢ increases to the gate-on voltage Von.

Subsequently, second gate signal VBᵢ changes into gate-off voltage Voff, and data signal Vdat is applied to data lines D₁-Dₘ. After a pre-determined time passes, first gate signal VAᵢ increases to the gate-on voltage Von, thereby initiating a data input period TA₃. After another pre-determined time passes, the first gate signal VAᵢ decreases to the gate-off voltage Voff, thereby initiating an emission period TA₄.

The pixel operation in each period of T1 to T4 is substantially the same as the operation illustrated in FIGS. 6A to 6D. Accordingly, further explanation is omitted.

The second gate signal line GB₀ provides a second gate signal VB₀ to a first pixel row (i.e., the second gate signal line GB₀ functions as a previous gate signal line and gate signal of the first pixel row).

Many features of the OLED shown in FIGS. 1 to 6D can be applied to OLED of FIGS. 7 to 9. As with the previous embodiments, the shift in the threshold voltage Vthd of the driving transistor Qd is compensated for, thereby preventing the deterioration in the display image quality. Also, the gate lines GC₁-GCₙ are omitted in this embodiment as the fourth switching transistor is connected to the previous second gate line instead of the third gate line, thereby eliminating a gate line and increasing a light emission area, resulting in an enhanced pixel aperture ratio.

According to the embodiments of the present invention, the capacitor of the pixel stores a shifted threshold voltage of the driving transistor, thereby applying a shifted threshold voltage of the driving transistor to the control terminal of the driving transistor and reducing the image degradation.

Although the invention has been described with reference to particular embodiments, the description is an example of the invention's application and should not be taken as a limitation. Various adaptations and combinations of the features of the embodiments disclosed are within the scope of the invention as defined by the following claims.

What is claimed is:

1. A display device comprising:
a light emitting element;
a driving transistor including a control terminal, an input terminal configured to receive a driving voltage, and an output terminal connected to the light emitting element;
a first capacitor connected to the control terminal of the driving transistor; and
a first switching transistor configured to transmit a data signal to the first capacitor in response to a first gate signal,
wherein the control terminal of the driving transistor receives a first voltage and the output terminal of the driving transistor receives a second voltage from the first voltage and the driving voltage.

2. The display device of claim 1, further comprising a second switching transistor configured to connect the first voltage to the control terminal of the driving transistor in response to a second gate signal.

3. The display device of claim 2, further comprising a third switching transistor configured to connect the first capacitor to the output terminal of the driving transistor in response to the second gate signal.

4. The display device of claim 3, further comprising a fourth switching transistor configured to connect the second voltage to the output terminal of the driving transistor in response to a third gate signal.

5. The display device of claim 4, wherein the third gate signal is a previous second gate signal.

6. The display device of claim 1, wherein the first voltage is greater than the second voltage.

7. The display device of claim 6, wherein the difference between the first voltage and the second voltage is greater than a threshold voltage of the driving transistor.

8. The display device of claim 6, wherein the second voltage is less than the sum of the common voltage and a threshold voltage of the light emitting element.

9. The display device of claim 6, wherein the sum of the common voltage and a threshold voltage of the light emitting element is greater than the difference between the first voltage and a threshold voltage of the driving transistor.

10. The display device of claim 1, wherein the first capacitor is coupled between the first and second voltages and is configured to store the difference between the first voltage and the second voltage and then store a threshold voltage of the driving transistor.

11. The display device of claim 1, further comprising a second capacitor coupled between the first capacitor and the first voltage.

12. A display device comprising:
a driving transistor including a control terminal connected to a first node, an output terminal connected to a second node, and an input terminal connected to a driving voltage;
a light emitting element connected to the second node;
a first capacitor connected between the first node and a third node;
a first switching transistor connected between the third node and a data line;
a second switching transistor connected to the first node and a first voltage;
a third switching transistor connected between the second node and the third node; and
a fourth switching transistor connected between the second node and a second voltage.

13. The display device of claim 12, further comprising a second capacitor connected between the first voltage and the third node.

14. The display device of claim 12, wherein the first switching transistor comprises a control gate connected to a first gate signal, the second and the third switching transistors comprise control gates connected to a second gate signal, and the fourth switching transistor comprises a control gate connected to a third gate signal.

15. The display device of claim 14, wherein the third gate signal is a previous second gate signal.

16. The display device of claim 14, further comprising a first, a second and a third gate line configured to transmit the first, the second, and the third gate signal, respectively.

17. The display device of claim 16, wherein the third gate line is a previous second gate line.

18. A method for driving a display device comprising a driving transistor having a control terminal connected to a first node, an output terminal connected to a second node, and an input terminal connected to a driving voltage, a light emitting element connected to the second node, and a capacitor connected between the first node and a third node, the method comprising:
connecting a first voltage to the second node to prevent the light emitting element from emitting light;
connecting a second voltage greater than the first voltage to the first node;
disconnecting the first voltage from the second node;
disconnecting the second voltage from the first node; and, connecting a data signal to the third node.

19. The method of claim 18, wherein connecting the second voltage to the first node comprises connecting the second node to the third node.

20. The method of claim 18, wherein disconnecting the second voltage from the first node comprises disconnecting the second node from the third node.

21. The method of claim 18, further comprising disconnecting the data signal from the third node.

22. A display device comprising:
a light emitting element;
a driving transistor including a control terminal, an input terminal configured to receive a driving voltage, and an output terminal connected to the light emitting element;
a capacitor connected to the control terminal of the driving transistor; and
a switching transistor connected between a data line and the output terminal of the driving transistor and having a control gate connected to a gate line, wherein the control terminal of the driving transistor is selectively coupled to a first voltage and the output terminal of the driving transistor is selectively coupled to a second voltage.
